(19) United States
(12) Patent Application Publication
(10) Pub. No.: US 2024/0385024 A1
(43) Pub. Date: Nov. 21, 2024

(54) EXTERIOR GAUGE COMPONENT FOR FUEL LEVEL MONITORING THAT IS COMPATIBLE WITH DIFFERENT TANK GAUGE HEADS

(71) Applicant: SERVICE INSIGHT LLC, MADISON, CT (US)

(72) Inventors: Anthony Uzzo, Madison, CT (US); James Gregory, Clinton, CT (US); Edward Davis, Old Saybrook, CT (US); Dante Fasano, Guilford, CT (US); Bruce Elder, Bridgeport, CT (US)

(21) Appl. No.: 18/644,089

(22) Filed: Apr. 23, 2024

Related U.S. Application Data
(60) Provisional application No. 63/461,324, filed on Apr. 23, 2023.

(51) Int. Cl. G01F 23/22; G01F 23/80

(52) U.S. Cl. CPC G01F 23/22; G01F 23/804

(57) ABSTRACT

Exterior gauge components configured to calculate and report heating day degrees are disclosed. Methods and systems for estimating current fuel consumption and tank capacity, and methods and systems for projecting future fuel consumption and tank capacity, are disclosed based on the reported heating day degrees. An improved exterior gauge component also is disclosed that further accommodates compatibility with and use on a plurality of different tanks by using a flexible, collapsible silicone cup component in which is contained at the distal end thereof a sensor for detecting rotational orientation of a tank magnet at the tank gauge head. A method of installation includes collapsing the silicone cup within a tank gauge head recess of the tank by inserting the silicone cup therein against a tank wall such that the silicone cup lies flush against the tank wall proximate the tank magnet on the other side of the tank wall.

### CROSS-REFERENCE TO RELATED APPLICATION

The present application is related in subject matter to and hereby incorporates by reference the disclosure of U.S. patent application publication 2023/0067868 A1, published Mar. 2, 2023. The present application also incorporates herein by reference U.S. patent application 63/461,324, from which priority is claimed.

### COPYRIGHT STATEMENT

Any new and original work of authorship in this document—including any source code—is subject to copyright protection under the copyright laws of the United States and other countries. Reproduction by anyone of this document as it appears in official governmental records is permitted, but otherwise all other copyright rights whatsoever are reserved.

### INCORPORATION OF COMPUTER PROGRAM LISTING APPENDIX

Submitted concurrently herewith via the USPTO's electronic filing system, and hereby incorporated herein by reference, is a computer program listing appendix representing computer program files including source code. The source code is for firmware that runs on the ESP-32 microcontroller chip architecture. The firmware runs an event timer that controls when a device wakes up and runs various functions like, for example, taking a temperature reading every hour; taking a tank level measurement once a day; or calculating a number of heating degree days that have occurred in the past 24 hours. The firmware issues commands to the device's cellular radio, which is used to transmit data over LTE-M (also known as Cat-M1) networks to Amazon Web Services servers. A table setting forth the name and size of files included in the computer program listing appendix is included below.

| File Name | Creation Date | File Size (bytes) |
|---|---|---|
| ascify.txt | Oct. 20, 2019 20:33 | 37,473 |
| readme.txt | Apr. 22, 2023 15:32:08 | 2,890 |
| firmware.txt | Apr. 22, 2023 14:41:55 | 187,483 |

One of these files, “readme.txt”, contains instructions for utilizing “ascify.txt” to convert each other ASCII file in this computer program listing into a compressed “.zip” file. The compressed “.zip” file resulting from “firmware.txt” comprises a folder with files and subfolders created using the Arduino 1.8.13 integrated development environment.

### BACKGROUND OF THE INVENTION

The invention generally relates to apparatus for indicating liquid levels in tanks as well as to systems in which such apparatus are used for predicting fuel needs and planning deliveries for refilling such tanks.

Exemplary apparatus for indicating liquid levels in tanks are disclosed in the incorporated patent application publication and references incorporated therein. While such apparatus for indicating liquid levels in tanks are believed to be adequate for performing their intended purposes, one or more needs are perceived to remain for improvements therein, which are believed to be addressed by one or more aspects and features of the invention.

### SUMMARY OF THE INVENTION

The invention includes many aspects and features. Moreover, while many aspects and features relate to, and are described in, the context of liquified propane (LP) gas tanks, the invention is not limited to use only in such context, as will become apparent from the following summaries and detailed descriptions of aspects, features, and one or more embodiments of the invention.

In an aspect, an exterior gauge component for attaching to a tank gauge head to monitor fuel level in a tank comprises: a housing; a base attached to the housing; a flexible, collapsible silicone cup component extending from the base in which is contained at a distal end thereof a sensor component for detecting rotational orientation of a tank magnet at a tank gauge head; and an adapter plate configured to attach to a plurality of different tank gauge heads, the adapter plate attached to the base and defining an opening through which the silicone cup component extends. Furthermore, the silicone cup component extends through and beyond the adapter plate such that the distal end of the silicone cup defines a furthermost portion of the exterior gauge component in the direction of extent of the silicone cup component.

In a feature, the silicone cup component has a plurality of hinge lines defining a portion of the silicone cup component that is collapsible such that the extent to which the silicone cup component extends from the base beyond the adapter plate is adjustable based on an extent of collapsing of the silicone cup component, the collapsibility of the silicone cup component accommodating varying recess depths of the plurality of the different tank gauge heads.

In a feature, the housing comprises a main circuit board, a wireless transceiver, and a power supply for powering of the exterior gauge component.

In a feature, the base is attached to the housing in covering relation to a bottom opening of the housing.

In a feature, a furthermost portion of the silicone cup component does not have the hinge lines and is not collapsible.

In a feature, the exterior gauge component comprises a circuit board contained within the distal end of the silicone cup component, the sensor component being attached to the circuit board. The portion of the silicone cup component that is not collapsible preferably defines an interior compartment of the distal end of the silicone cup component that corresponds in size and dimension to a profile of the sensor component attached to the circuit board, whereby the sensor component and the circuit board are received and retained within the non-collapsible portion of the silicone cup component. The interior compartment preferably includes a profile by which an orientation of the circuit board is predetermined, the circuit board only fitting in one orientation within and relative to the silicone cup component. The profile of the interior compartment for receiving the circuit board preferably has a single axis of symmetry such that the circuit board fits within the profile at only one angular orientation relative to the silicone cup component, whereby the angular rotation of the sensor component mounted to the circuit board is thereby fixed relative to the silicone cup component. Additionally, the silicone cup component preferably comprises channels for insertion and retention therein of a rim of the base, and the channels are separated by channel end walls that serve to lock the silicone cup component in a fixed orientation relative to the base, the silicone cup component being blocked thereby from rotation relative to the base.

In a feature, the silicone cup component comprises an inner wall that serves as a stop precluding collapsing of the collapsible portion beyond a certain extent. Preferably, the inner wall engages the base and stops further collapsing of the silicone cup component after the certain extent collapsing. The inner wall also preferably is circular in profile, concentric with a bottom round wall of the silicone cup component and extends upwardly toward a mouth of the silicone cup component.

In a feature, the housing comprises a button for manually turning the gauge component on and off.

In a feature, the housing further comprises a threaded connection on a top wall thereof for mounting of an antenna for wireless communications.

In a feature, the base is removably connected to the housing by threaded fasteners, and further comprising a gasket sandwiched between the housing and the base for sealing the interior of the housing.

In a feature, the adapter plate is configured to attach to the base in a snap-fit connection.

In a feature, the adapter plate is configured to mount to different tank gauge heads.

In a feature, a proximal end portion of the exterior gauge component comprises a collapsible, silicone cup component that extends through an opening of the adapter plate to the other side of the adapter plate and beyond.

In a feature, the power supply comprises one or more batteries.

In a feature, the main circuit board comprises circuitry for detecting the temperature of an outdoor environment in which the tank is located. The exterior gauge component preferably is configured to calculate and wirelessly communicate heating day degrees for a location at which the exterior gauge component is used.

In another aspect, a tank comprises a gauge head and an exterior gauge component attached to the gauge head. The exterior gauge component comprises: a housing comprising a main circuit board, a wireless transceiver, and a power supply for powering of the exterior gauge component; a base attached to the housing in covering relation to an opening of the housing; a flexible, collapsible silicone cup component extending from the base in which is contained at a distal end thereof a sensor component for detecting rotational orientation of a tank magnet at a tank gauge head; and an adapter plate configured to attach to a plurality of different tank gauge heads, the adapter plate attached to the base and defining an opening through which the silicone cup component extends. The silicone cup component extends through and beyond the adapter plate such that the distal end of the silicone cup defines a furthermost portion of the exterior gauge component in the direction of extent of the silicone cup component.

In a feature, the silicone cup component has a plurality of hinge lines defining a portion of the silicone cup component that is collapsible such that the extent to which the silicone cup component extends from the base beyond the adapter plate is adjustable based on an extent of collapsing of the silicone cup component, the collapsibility of the silicone cup component accommodating varying recess depths of the plurality of the different tank gauge head.

In a feature, the housing of the exterior gauge component comprises a display configured to provide an indication of a liquid level in the tank.

In a feature, a proximal end portion of the exterior gauge component comprises a collapsible, silicone cup that extends through an opening of the adapter plate to the other side of the adapter plate and beyond within a recess of the gauge head of the tank proximate a wall of the tank, on the other side of which wall the tank magnet is located.

In a feature, the silicone cup comprises a circuit board having a sensor component (magnetic sensor ICs) for detecting the orientation of the tank magnet, by which detection of the orientation of the tank magnet the liquid level in the tank can be determined.

In a feature, the distal end of the silicone cup component within the gauge head recess of the tank lies flush against a tank wall of the tank proximate the tank magnet on the other side of the tank wall.

In a feature, the sensor component is attached to the circuit board and is located between the circuit board and a bottom wall of the silicone cup.

In a feature, the circuit board is connected by wires to a main circuit board contained within the housing.

In a feature, the silicone cup is in a collapsed, compressed state in abutment with the wall of the tank within the recess of the tank gauge head.

In a feature, as a result of the flexible, collapsible silicone cup, the sensor component sits flush on top of the tank wall within the recess of the tank gauge head.

In a feature, the exterior gauge component is configured to calculate and wirelessly communicate heating day degrees.

In another aspect of the invention, an exterior gauge component comprises a silicone cup for extension within a gauge head recess of a tank. In a feature thereof, the silicone cup comprises a sensor component for determining the rotational orientation of a magnet of the tank at the gauge head recess by which the fuel level/fuel capacity of the tank is determined.

Another aspect relates to an exterior gauge component as disclosed herein.

Another aspect relates to an exterior gauge component configured to calculate and report heating day degrees.

Another aspect relates to a system for estimating fuel consumptions within a localized geographical area for an unmonitored location using a plurality of monitored locations within the localized geographical area. In a feature, each monitored location calculates an HDD for that location and transmits that HDD daily to a server from the monitored location.

Another aspect relates to a method for estimating fuel consumption and/or capacity of a tank for an unmonitored location based on monitored locations within a localized geographical location of said unmonitored location.

Another aspect relates to a method for predicting future fuel consumption and/or capacity of a tank for an unmonitored location based on monitored locations within a localized geographical location of said unmonitored location.

Additional aspects and features are disclosed in the incorporated patent applications.

Furthermore, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings, wherein the same elements are referred to with the same reference numerals, and wherein,

FIG. 1 is a front elevational view of a preferred embodiment of an exterior gauge component in accordance with one or more aspects and features of the invention.

FIG. 2 is a perspective view of a bottom of the exterior gauge component of FIG. 1 without the adapter plate.

FIG. 3 is a perspective view of the base and housing of the exterior gauge component of FIG. 1 separated to reveal the circuit board within the housing, the circuit board within the silicone cup, and the wires interconnecting the two.

FIG. 4 is a side elevational view of the base with the silicone cup extending therefrom.

FIG. 5 is a perspective view of a sensor component contained within a bottom of the silicone cup.

FIG. 6 is a profile of the sensor component of FIG. 5 mounted to the circuit board of the silicone cup of FIG. 3.

FIG. 7 is a perspective view of the silicone cup.

FIG. 8 is a top plan view of the silicone cup.

FIG. 9 is a bottom plan view of the silicone cup.

FIG. 10 is a front elevational view of the silicone cup and is representative of the back elevational view thereof.

FIG. 11 is a first side elevational view of the silicone cup and is representative of the opposite side elevational view thereof.

FIG. 12 is a shaded view of FIG. 7.

FIG. 13 is a shaded view of FIG. 8.

FIG. 14 is a shaded view of FIG. 9.

FIG. 15 is a shaded view of FIG. 10.

FIG. 16 is a shaded view of FIG. 11.

FIG. 17 is an elevational view in cross-section of the silicone cup of FIG. 11.

FIG. 18 is an elevational view in cross-section of the silicone cup of FIG. 10.

FIG. 19 is a perspective view in cross-section of the silicone cup of FIG. 12.

FIG. 20 is a perspective view in cross-section of the silicone cup of FIG. 13.

FIG. 21 is a shaded view of FIG. 17.

FIG. 22 is a shaded view of FIG. 18.

FIG. 23 is a shaded view of FIG. 19.

FIG. 24 is a shaded view of FIG. 20.

FIG. 25 is a schematic illustration of the circuit board of the housing of the exterior gauge component of FIG. 1.

FIG. 26 is an illustration of a map of an area showing airports at which temperatures are measured for conventionally determining Heating Degree Days (HDD).

FIG. 27 is an illustration of a map of the area of FIG. 17 showing installations of preferred exterior gauge components in accordance with one or more aspects and features of the invention at which temperatures are measured for determining heating day degrees in accordance with the present invention.

FIG. 28 is an illustration of a graphical user interface of an application (“Insight Platform”) showing present and historical fuel capacity and for showing future predicted fuel capacity of a tank to which is mounted a preferred exterior gauge component in accordance with one or more aspects and features of the invention.

FIG. 29 discloses steps of preferred methods in a preferred system in accordance with one or more aspects and features of the invention.

FIG. 30 is a schematic illustration of a preferred embodiment of an exterior gauge component in accordance with one or more aspects and features of the invention being attached to a gauge head of a tank.

FIG. 31 is a schematic illustration of the exterior gauge component of FIG. 30 attached to the tank gauge head.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112 (f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

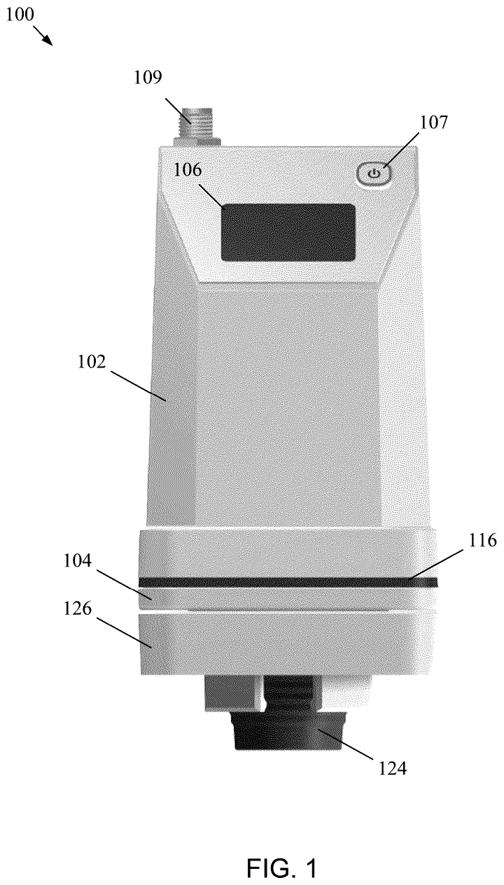

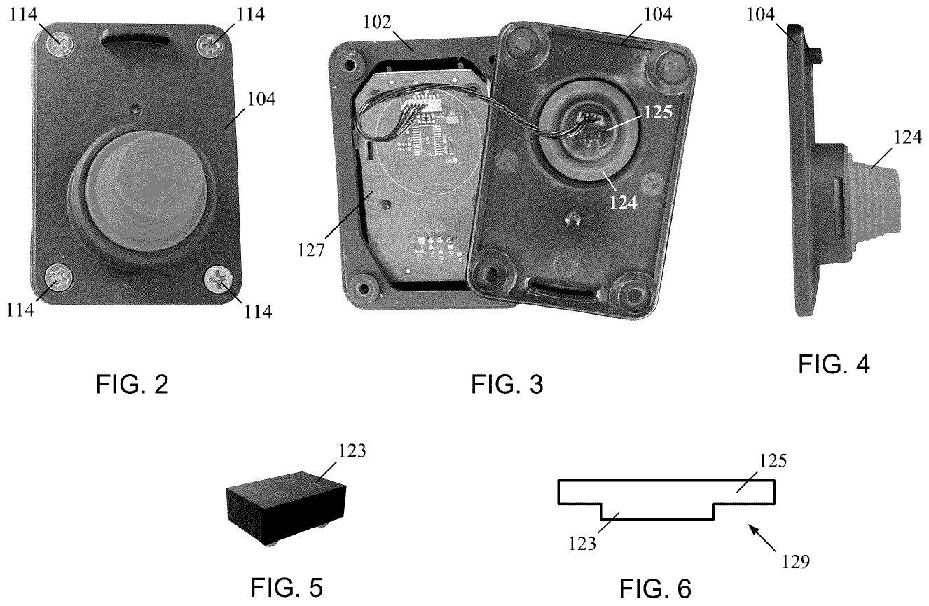

Turning now to FIG. 1, this figure shows a front elevational view of a preferred embodiment of an exterior gauge component 100 (sometimes referred to as an “LP monitor”) in accordance with one or more aspects and features of the invention. The exterior gauge component 100 comprises a housing 102, a base 104, and an adapter plate 126. The housing 102 comprises a display 106 for displaying an indication of a liquid level in a tank when attached to a gauge head of the tank, a power button 107, and a threaded connection for an antenna 109. The base 104 is removably connected to the housing 102 by screws 114 (shown in FIG. 2) with a gasket 116 sandwiched between the housing 102 and base 104 for sealing the interior of the housing 102. The adapter plate 126 attaches to the base 104 preferably in a snap-fit connection and further is configured for mounting to a gauge head of various tanks.

In this respect, the adapter plate makes the exterior gauge component 100 “universal” in terms of compatibility of the exterior gauge component 100 with tanks of different manufacturers. The “adapter plate” allows the exterior gauge component 100 to be retrofitted on many different LP tank gauge heads.

In mounting the exterior gauge component 100 to a gauge head of a tank, a proximal end portion of the exterior gauge component 100 comprises, in accordance with an aspect of the invention, a collapsible, silicone cup 124 that extends through an opening of the adapter plate 126 to the other side of the adapter plate 126 and beyond so as to be the furthermost portion of the exterior gauge component 100 (the collapsible, silicone cup 124 is the lowermost portion as shown in FIG. 1). A side elevational view of just the base 104 with silicone cup 124 extending therefrom is shown in FIG. 4. When mounted, the collapsible, silicone cup 124 thus extends within a recess of the gauge head of the tank proximate a wall of the tank, on the other side of which wall the tank magnet is located.

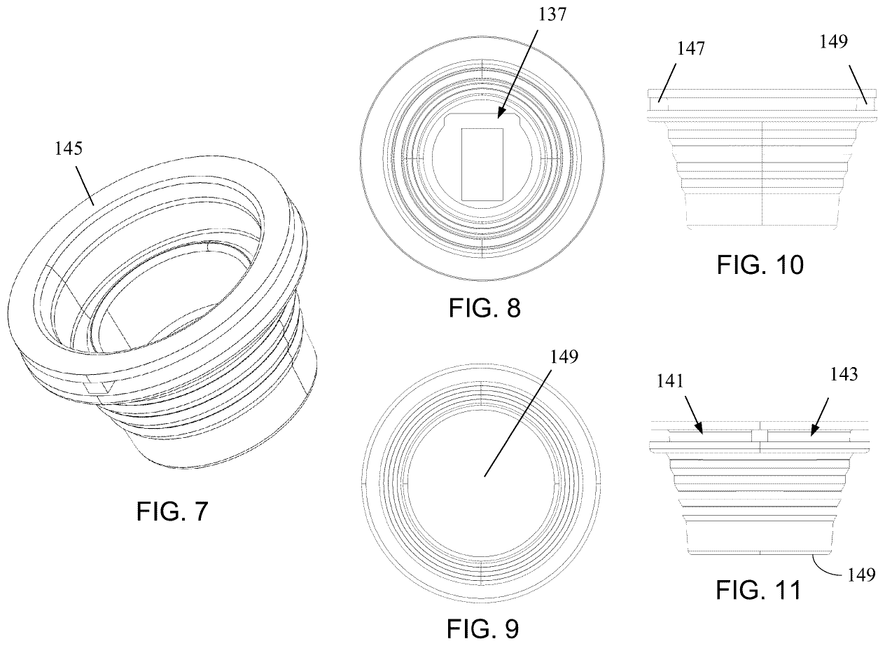

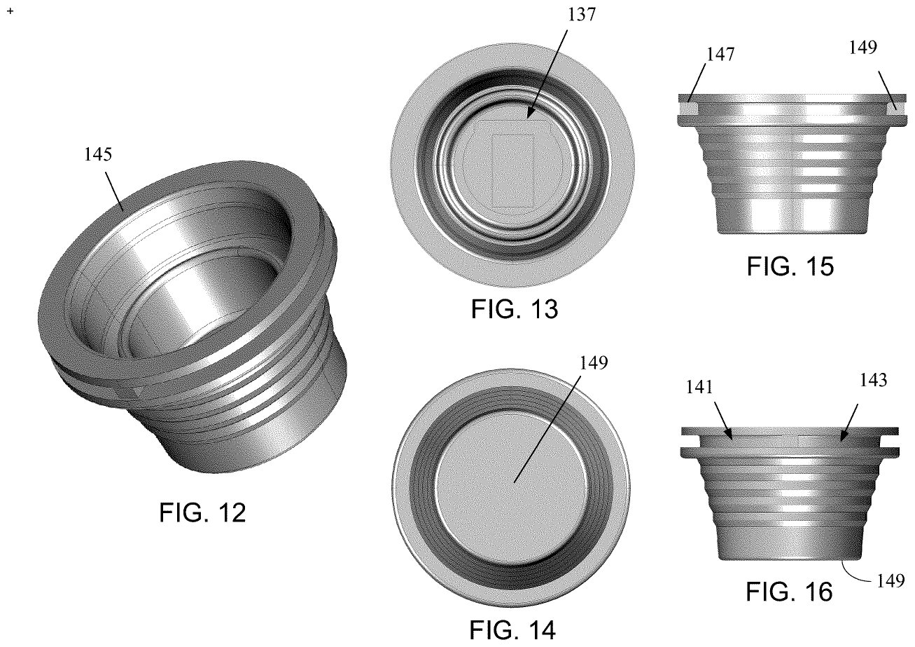

FIG. 7 is a perspective view of the silicone cup and FIG. 12 is a shaded view corresponding to the view of FIG. 7. Additionally, FIG. 8 is a top plan view of the silicone cup and FIG. 13 is a shaded view corresponding to the view of FIG. 8; FIG. 9 is a bottom plan view of the silicone cup and FIG. 14 is a shaded view corresponding to the view of FIG. 9; FIG. 10 is a front elevational view of the silicone cup and is representative of the back elevational view thereof and FIG. 15 is a shaded view corresponding to the view of FIG. 10; and FIG. 11 is a first side elevational view of the silicone cup and is representative of the opposite side elevational view thereof and FIG. 16 is a shaded view corresponding to the view of FIG. 11.

The collapsible, silicone cup 124 comprises a circuit board 121 having a sensor component 123 (magnetic sensor ICs) for detecting the orientation of the tank magnet. By detecting the orientation of the tank magnet, the liquid level in the tank can be determined. A preferred sensor component is commercially known as “AK09973D” and sold by Asahi Kasei Microdevices Corporation. Specifications for the AK09973D are disclosed in the appendix to the specification, which is incorporated herein by reference. The sensor component 123 itself is shown in FIG. 5, and a profile 129 of the sensor component 123 attached to the circuit board 121 is shown in FIG. 6. The circuit board 121 is connected by wires to a main circuit board 127 contained within the housing 102. FIG. 3 shows the housing 102 and base 104 separated with the wires connecting the circuit board of the silicone cup and the main circuit board of the housing.

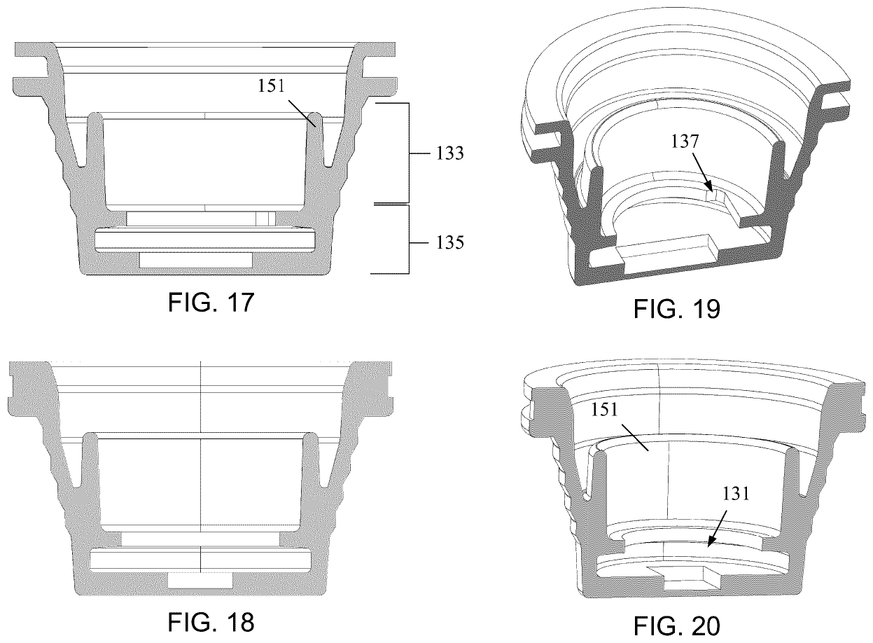

It will be appreciated that the closer the sensor component 123 contained within the silicone cup 124 is positioned to the wall of the tank, the better the sensor component 123 will be able to detect the orientation of the magnet within the tank. Unfortunately, gauge heads of different tanks do not have the exact same recess depth. To address this and to facilitate compatibility of the exterior gauge component 100 with a plurality of different tanks, the silicone cup 124 has a plurality of hinge lines that define a collapsible portion 133 (FIG. 17) such that the extent to which the silicone cup 124 extends from the base 104 beyond the adapter plate 126 is variable by collapsing the silicone cup 124. Collapsing of the silicone cup 124 is effected when the exterior gage head is mounted to the tank, with the silicone cup 124 being compressed against the wall of the tank within the recess of the tank gauge head. As a result, the flexible, collapsible silicone cup 124 ensures the distal end of the silicone cup 124 containing the sensor component 123 sits flush on top of the tank wall within the recess of the tank gauge head, thereby increasing the field strength of the magnet inside the tank and, in turn, increasing the accuracy of the measurement from the sensor component 123.

While the silicone cup 124 comprises the collapsible portion 133, the furthest portion 135 of the silicone cup 124 that lacks the hinge lines is not collapsible (FIG. 17). This non-collapsible portion 135 of the silicone cup 124 defines a compartment 131 that is sized and dimensioned to correspond to the profile of the sensor component 123 attached to the circuit board 125, as shown in FIG. 6, whereby the sensor component 123 and the circuit board 125 to which it is mounted are received and retained within the non-collapsible portion 135 of the silicone cup 124. Furthermore, the compartment 123 includes a profile 137 by which an orientation of the circuit board 125 is predetermined because the circuit board 125 will fit in only one orientation relative to the silicone cup 124. This is perhaps best shown in FIG. 8, wherein the profile 137 of the compartment 131 for receiving the circuit board 125 has a single axis of symmetry such that the circuit board 125 “fits” within the profile at only one angular orientation relative to the silicone cup 124. The angular rotation of the sensor component 123 mounted to the circuit board 125 is thereby fixed relative to the silicone cup 124.

The silicone cup furthermore includes channels 141,143 for insertion and retention of a rim 145 of the silicone cup 124 within the base 104. The channels 141,143 are separated by channel end walls 147,149. This arrangement locks the silicone cup 124 in a fixed orientation relative to the base 104 when inserted and retained thereto; the silicone cup 124 is blocked from rotation relative to the base 104. This ensures that the orientation of the sensor 123 is known relative to the base 104 and, overall, the exterior gauge component 100 when mounted to a gauge head of a tank. With this knowledge, an accurate rotational orientation of the magnet within the tank can be determined and, in turn, an accurate level of liquid in the tank.

With further regard to the silicone cup 124, an inner wall 151 is provided that serves as a stop precluding collapsing of the portion 133 beyond a certain extent. The wall 151 preferably is circular in profile, concentric with the bottom round wall 149 of the silicone cup 124 and extends upwardly toward a mouth of the silicone cup 124. When the silicone cup 124 collapses, the wall 151 preferably engages the base 104 and stops further collapsing of the silicone cup 124. The wall 151 serves a safety function that keeps the sensor component 123 and circuit board 125 from being crushed or otherwise damage upon too great of an extent of collapsing of the silicone cup 124.

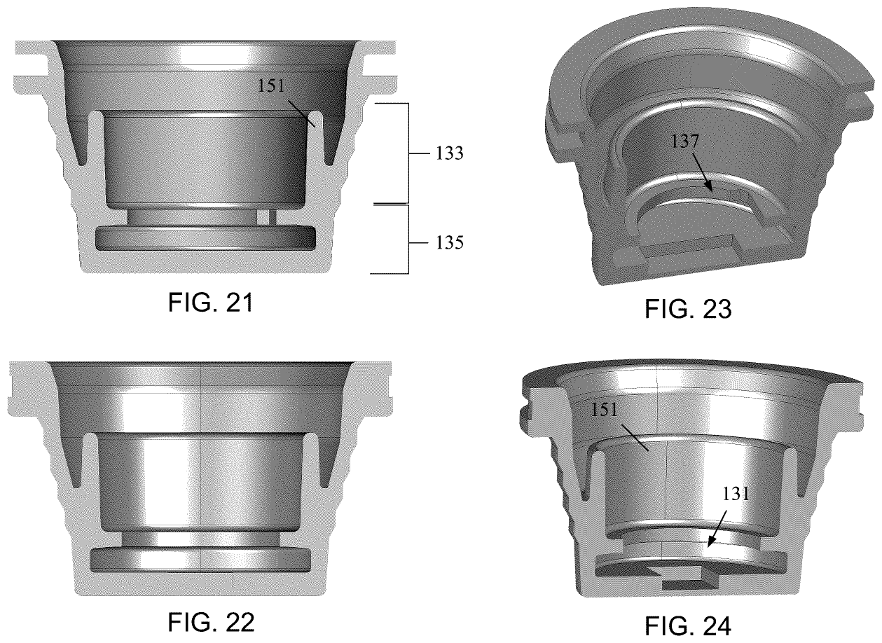

FIG. 17 is an elevational view in cross-section of the silicone cup of FIG. 11 and FIG. 21 is a shaded view corresponding to the view of FIG. 21. Additionally, FIG. 18 is an elevational view in cross-section of the silicone cup of FIG. 10 and FIG. 22 is a shaded view corresponding to the view of FIG. 18; FIG. 19 is a perspective view in cross-section of the silicone cup of FIG. 12 and FIG. 23 is a shaded view corresponding to the view of FIG. 19; and FIG. 20 is a perspective view in cross-section of the silicone cup of FIG. 13 and FIG. 24 is a shaded view corresponding to the view of FIG. 20.

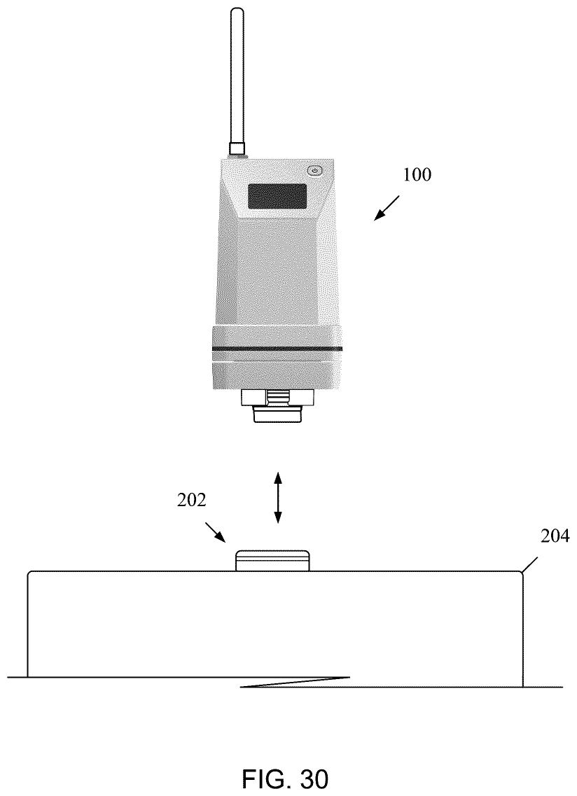

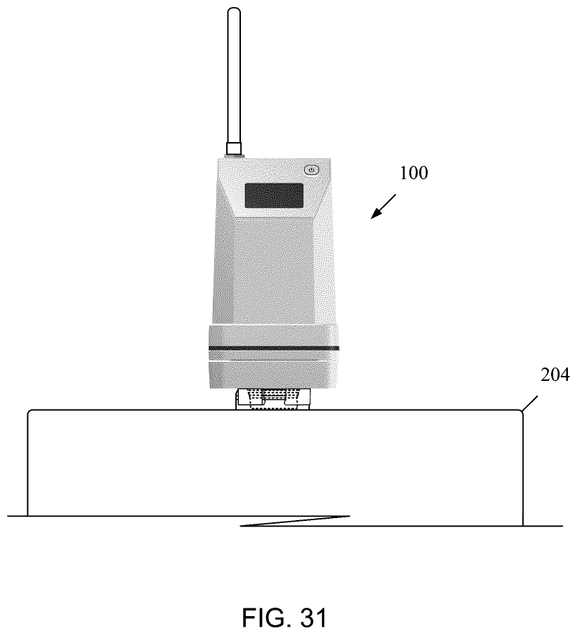

FIG. 30 is a schematic illustration of the exterior gauge component 100 being attached to a gauge head 202 of a tank 204; and FIG. 31 is a schematic illustration of the exterior gauge component 100 attached to the tank gauge head 202.

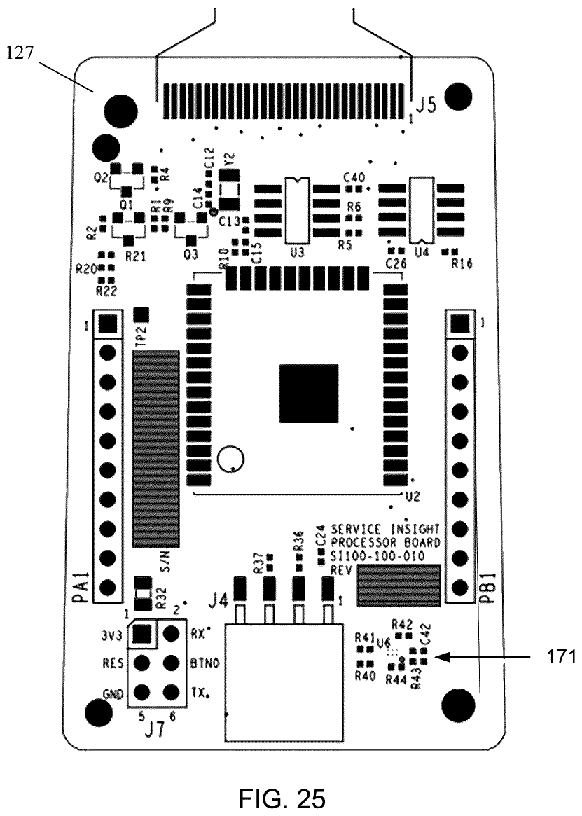

The main circuit board 127 of the housing 104 is schematically illustrated in FIG. 25. In preferred embodiment, the main circuit board 127 comprises circuitry 171 for detecting the temperature of the outdoor environment in which the tank is located to which tank the exterior gauge component 100 is mounted. The circuitry 171 preferably represents an ultra-sensitive temperature sensor. The housing 104 also preferably comprises a wireless transceiver and power supply for powering of the electrical components of the exterior gauge component 100. The power supply preferably comprises one or more batteries.

In accordance with another aspect of the invention, the exterior gauge component 100 is configured through firmware to wake-up and measure the outdoor temperature at the tank at periodic time intervals during a twenty-four-hour period, such as hourly, and to calculate a heating degree day for that location (HDD). The base temperature preferably is 65 degrees Fahrenheit but may be different depending on location and convention. The HDD is wirelessly transmitted to a server and, preferably, are transmitted once a day to one or more Amazon Web Services (AWS) servers. The HDD preferably is associated with the location, such as by including the latitude and longitude of the location. The wireless transmission of the data preferably is over cellular networks, such as CAT-MI and NB-IoT networks. Other networks may be utilized, such as Wi-Fi and LoRa networks. Protocol that may be used include HTTPS and MQTT protocols. A plurality of exterior gauge components preferably is installed over a large geographical area and each reports its respective HDD each day.

At the one or more servers, the exterior gauge components are grouped or clustered by location, preferably comprising between 10 and 20 locations within a 10-to-20-mile radius—the closer the better. For each cluster, an average HDD for the cluster is calculated over the HDD reported by each exterior gauge component of the cluster. Exterior gauge components may form part of more than one cluster depending on the geographical distribution of the exterior gauge components.

With the HDD of a localized geographical area thus being calculated as the said average, the HDD localized geographical area can be used to estimate fuel consumption at each location within the localized geographical area where the k-factor for that location is known. (As used herein, the “k-factor” is an indication of how many degree days it takes for a customer to burn one gallon of fuel.) Importantly, each location need not have one of the exterior gauge components. Only the k-factor need be known for that location to estimate the daily fuel consumption, and the k-factor can be determined by a fuel provider based on historical data from fuel deliveries and past temperatures.

In a preferred commercial embodiment, a subscription service is provided for such fuel providers wherein the fuel consumed within a localized geographical area (a cluster) is provided for each service location within that area. Furthermore, based on future weather/temperature forecasts for that area and the HDDs determined for that area, future fuel consumption within that area can better be calculated and that forecast information can be provided as part of the service to the fuel providers.

In a feature of the invention, if there are an insufficient number of exterior gauge components within a given localized geographical area, then hourly temperature forecast data for the given localized geographical area from an online weather service accessed through an API preferably is used as a substitute for the HDD data, and refinement of the set comprising a cluster for a monitored degree day service location preferably occurs as more exterior gauge components are deployed in the given localized geographical area such that the substitution of the online weather service may be omitted.

Preferably, in a system for fuel consumption forecasting using hourly temperature forecasts, each day the system will use a four-to-seven-day hourly temperature forecast to calculate the predicted heating degree days (HDD) for each location. The predicted daily fuel consumption for each tank is then calculated using the forecast HDD and the address-specific k-factor. Any location falling below the threshold for an alert or for a warning then can be precalculated and a delivery scheduled so as to avoid such alert or warning. Indeed, by projecting when customers will run out of fuel, fuel providers (dealers) will have even more control when planning fuel deliveries.

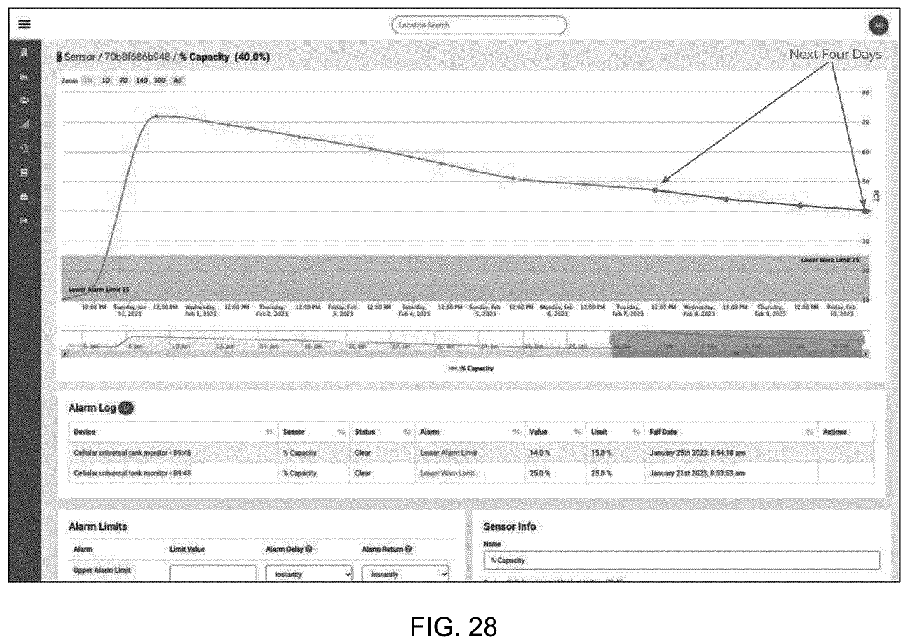

FIG. 28 is an illustration of a graphical user interface of an application (“Insight Platform”) showing present and historical fuel capacity and for showing future predicted fuel capacity of a tank to which is mounted a preferred exterior gauge component in accordance with one or more aspects and features of the invention.

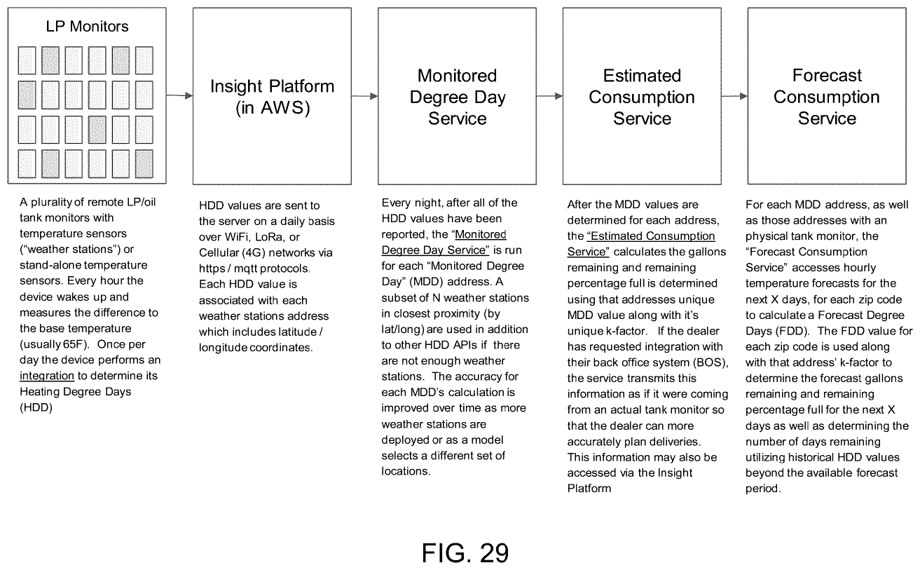

Steps of preferred methods in a preferred system in accordance with one or more aspects and features of the invention are disclosed in FIG. 29.

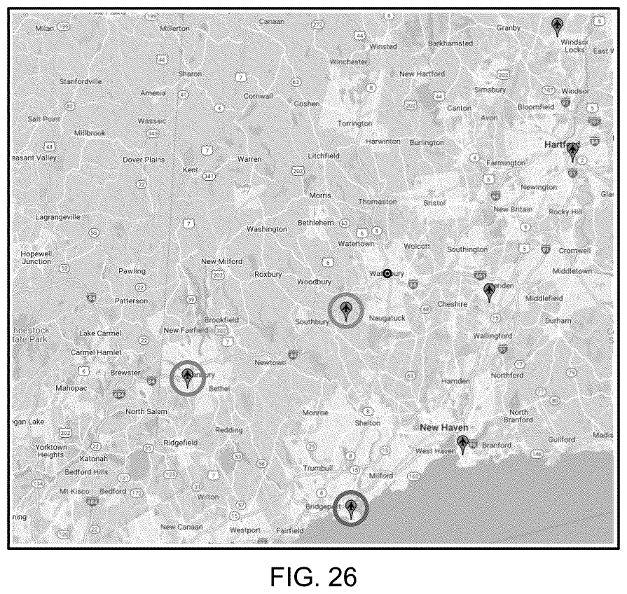

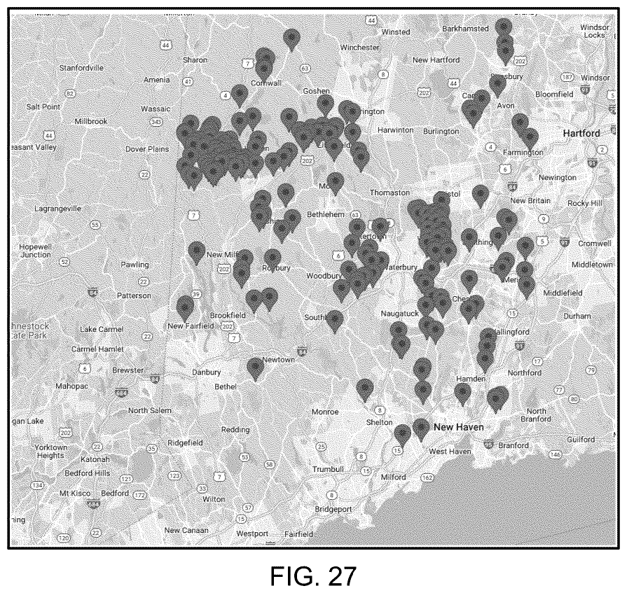

Among the benefits of the above-described preferred embodiments of the invention, it is believed that HDDs predictions will be more accurate because of the localized geographical areas of the clusters in which the HDDs are calculated. Currently HDDs are calculated based on temperature measurements at airports. For example, FIG. 26 illustrates three airports that are used in the geographical area shown for calculating HDDs. It is believed that localized geographical areas based on clusters of subsets of the locations shown in FIG. 27 would lead to more accurate HDDs resulting in increased efficiencies not only for monitored locations within the localized geographical area of a cluster, but also for unmonitored locations within the localized geographical area of a cluster.

From the foregoing, it will be appreciated that exterior gauge components configured to calculate and report heating day degrees have been disclosed. Methods and systems for estimating current fuel consumption and tank capacity, and methods and systems for projecting future fuel consumption and tank capacity, also have been disclosed based on the reported heating day degrees. This includes for monitored and unmonitored locations within a localized geographical area having a sufficient number of monitored locations and/or temperature data acquired through an API of an online weather service that provides temperature data for the localized geographical area. An improved exterior gauge component also has been disclosed that further accommodates compatibility with and use on a plurality of different tanks by using a flexible, collapsible silicone cup component in which is contained at the distal end thereof a sensor for detecting rotational orientation of a tank magnet at the tank gauge head. A method of installation further has been disclosed that includes collapsing the silicone cup within the gauge head recess of the tank by inserting the silicone cup therein against a wall of the tank such that the silicone cup lies flush against the tank wall proximate the tank magnet on the other side of the tank wall.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1. An exterior gauge component for attaching to a tank gauge head to monitor fuel level in a tank, comprising:
(a) a housing comprising a main circuit board, a wireless transceiver, and a power supply for powering of the exterior gauge component;
(b) a base attached to the housing in covering relation to an opening of the housing;
(c) a flexible, collapsible silicone cup component extending from the base in which is contained at a distal end thereof a sensor component for detecting rotational orientation of a tank magnet at a tank gauge head;
(d) an adapter plate configured to attach to a plurality of different tank gauge heads, the adapter plate attached to the base and defining an opening from which the silicone cup component extends, a portion of the base extending through the opening in the adapter plate;
(e) wherein the silicone cup component extends beyond the adapter plate such that the distal end of the silicone cup defines a furthermost portion of the exterior gauge component in the direction of extent of the silicone cup component; and
(f) wherein the silicone cup component has a plurality of hinge lines defining a portion of the silicone cup component that is collapsible such that the extent to which the silicone cup component extends from the base beyond the adapter plate is adjustable based on an extent of collapsing of the silicone cup component, the collapsibility of the silicone cup component accommodating varying recess depths of the plurality of the different tank gauge heads.

2. The exterior gauge component of claim 1, wherein a furthermost portion of the silicone cup component does not have the hinge lines and is not collapsible.

3. The exterior gauge component of claim 1, further comprising a circuit board contained within the distal end of the silicone cup component, the sensor component being attached to the circuit board.

4. The exterior gauge component of claim 3, wherein the portion of the silicone cup component that is not collapsible defines an interior compartment of the distal end of the silicone cup component that corresponds in size and dimension to a profile of the sensor component attached to the circuit board, whereby the sensor component and the circuit board are received and retained within the non-collapsible portion of the silicone cup component.

5. The exterior gauge component of claim 4, wherein the interior compartment includes a profile by which an orientation of the circuit board is predetermined, the circuit board only fitting in one orientation within and relative to the silicone cup component.

6. The exterior gauge component of claim 4, wherein the profile of the interior compartment for receiving the circuit board has a single axis of symmetry such that the circuit board fits within the profile at only one angular orientation relative to the silicone cup component, whereby the angular rotation of the sensor component mounted to the circuit board is thereby fixed relative to the silicone cup component.

7. The exterior gauge component of claim 6, wherein the silicone cup component comprises channels for insertion and retention therein of a rim of the base, and wherein the channels are separated by channel end walls that serve to lock the silicone cup component in a fixed orientation relative to the base, the silicone cup component being blocked thereby from rotation relative to the base.

8. The exterior gauge component of claim 1, wherein the silicone cup component comprises an inner wall that serves as a stop precluding collapsing of the collapsible portion beyond a certain extent.

9. The exterior gauge component of claim 8, wherein the inner wall engages the base and stops further collapsing of the silicone cup component after the certain extent collapsing.

10. The exterior gauge component of claim 8, wherein the inner wall is circular in profile, concentric with a bottom round wall of the silicone cup component and extends upwardly toward a mouth of the silicone cup component.

11. (canceled)

12. The exterior gauge component of claim 1, wherein the housing further comprises a threaded connection on a top wall thereof for mounting an antenna for wireless communications.

13. The exterior gauge component of claim 1, wherein the base is removably connected to the housing by threaded fasteners, and further comprising a gasket sandwiched between the housing and the base for sealing the interior of the housing.

14. The exterior gauge component of claim 1, wherein the adapter plate is configured to attach to the base in a snap-fit connection.

15-16. (canceled)

17. The exterior gauge component of claim 1, wherein the power supply comprises one or more batteries.

18. The exterior gauge component of claim 1, wherein the main circuit board comprises circuitry for detecting the temperature of an outdoor environment in which the tank is located.

19. The exterior gauge component of claim 18, wherein the exterior gauge component is configured to calculate and wirelessly communicate heating day degrees for a location at which the exterior gauge component is used.

20. A tank comprising a gauge head and an exterior gauge component attached to the gauge head, wherein the exterior gauge component comprises:
(a) a housing comprising a main circuit board, a wireless transceiver, and a power supply for powering of the exterior gauge component;
(b) a base attached to the housing in covering relation to an opening of the housing;
(c) a flexible, collapsible silicone cup component extending from the base in which is contained at a distal end thereof a sensor component for detecting rotational orientation of a tank magnet at a tank gauge head;
(d) an adapter plate configured to attach to a plurality of different tank gauge heads, the adapter plate attached to the base and defining an opening from which the silicone cup component extends, a portion of the base extending through the opening in the adapter plate;
(e) wherein the silicone cup component extends beyond the adapter plate such that the distal end of the silicone cup defines a furthermost portion of the exterior gauge component in the direction of extent of the silicone cup component; and
(f) wherein the silicone cup component has a plurality of hinge lines defining a portion of the silicone cup component that is collapsible such that the extent to which the silicone cup component extends from the base beyond the adapter plate is adjustable based on an extent of collapsing of the silicone cup component, the collapsibility of the silicone cup component accommodating varying recess depths of the plurality of the different tank gauge heads.

21-22. (canceled)

23. The tank of claim 20, wherein the silicone cup comprises a circuit board having a sensor component for detecting the orientation of the tank magnet, by which detection of the orientation of the tank magnet the liquid level in the tank can be determined.

24. The tank of claim 20, wherein the distal end of the silicone cup component within the gauge head recess of the tank lies flush against a tank wall of the tank proximate the tank magnet on the other side of the tank wall.

25-30. (canceled)

31. The tank of claim 23, wherein the sensor component of the silicone cup comprises a magnetic sensor integrated circuit.
